(19) United States
(12) Patent Application Publication
(10) Pub. No.: US 2011/0102915 A1
(43) Pub. Date: May 5, 2011

(54) DEVICE TO CREATE HIGH DEFINITION PHOTOS

(76) Inventors: Michael Pham, Westminster, CA (US); Thanh Tan Tran, Westminster, CA (US)

(21) Appl. No.: 12/609,310

(22) Filed: Oct. 30, 2009

(51) Int. Cl. G02B 9/00

(52) U.S. Cl. 359/738

(57) ABSTRACT

A device to create high definition photos includes: a lens for receiving light and transmitting an image; and a plurality of parallel blocking rods to delay the light within the lens; wherein the lens receives the light, the rods delay the light, and the lens transmits the delayed light, thereby providing an enhanced image of the item.

### BACKGROUND OF THE INVENTION

The present invention generally relates to photography, and more specifically, to a device to create high definition photos.

### SUMMARY OF THE INVENTION

In one aspect of the present invention, a device for providing an enhanced image of an item or items includes: a lens for receiving light and transmitting an image; and a plurality of parallel blocking rods to delay the light within the lens; wherein the lens receives the light, the rods delay the light, and the lens transmits the delayed light, thereby providing an enhanced image of the item.

In another aspect of the present invention, a lens includes: a plurality of light blocking rods a different orientations so as to delay light within the lens.

In yet another aspect of the present invention, a method of providing an enhanced image includes: receiving a first image into a lens; delaying the light within the lens utilizing a plurality of parallel blocking rods; and transmitting the delayed light out of the lens; thereby providing an enhanced image.

These and other features, aspects and advantages of the present invention will become better understood with reference to the following drawings, description and claims.

### BRIEF DESCRIPTION OF THE DRAWINGS

FIG. 1 depicts a front view of an embodiment of the present invention;

FIG. 2 depicts a side view of an embodiment of the present invention;

FIG. 3 depicts an exploded view of an embodiment of the present invention;

FIG. 4 depicts a view of an embodiment of the present invention with a camera; and

FIG. 5 depicts an embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a device to create high definition (HD) photos. Embodiments do not require additional software for editing or creating.

An embodiment provides improvements to flat photos or regular images. Embodiments create totally different levels of photos. It produces another dimension in photos and creates high definition photos.

Embodiments include rings or discs that are transparently glued together or molding during manufacture to stick together.

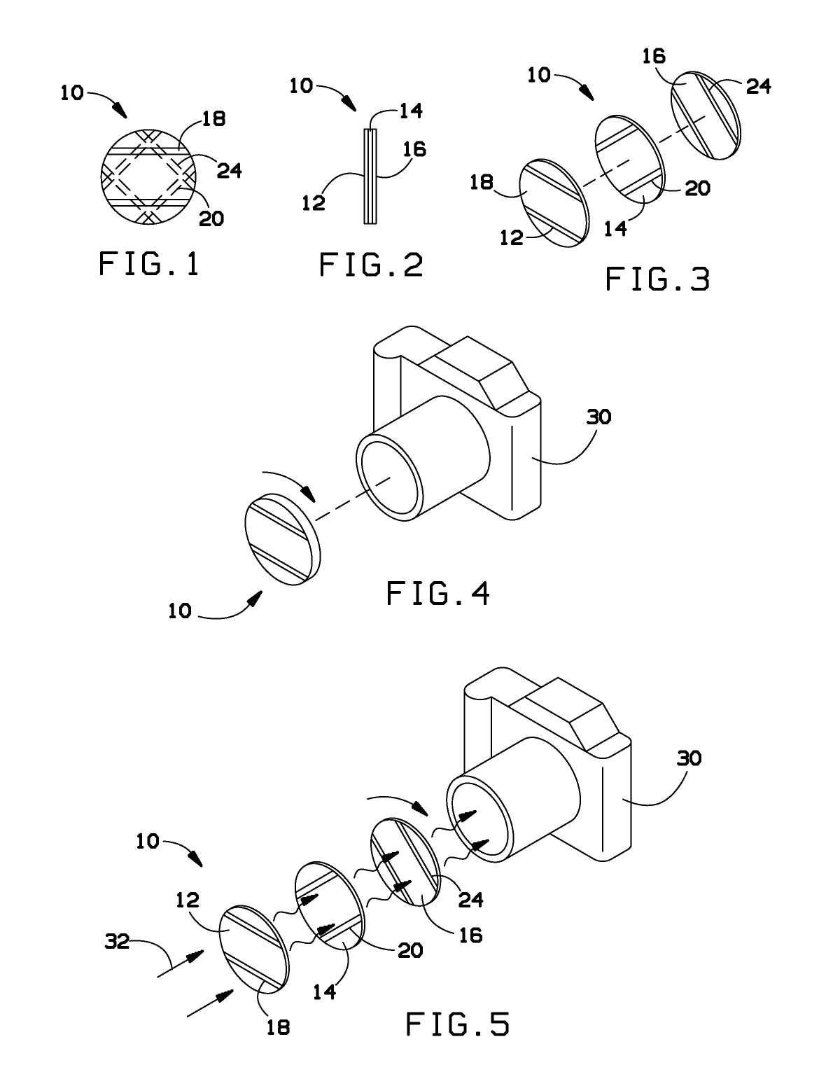

As depicted in FIGS. 1, 2, and 3, an embodiment 10 of the present invention includes a plurality of transparent lenses or layers 12, 14, 16 having parallel rods 18, 20, 24, orientated at different angles, layered together to form a high-definition device.

Embodiments effectively slow down and bounce the light through rods to create high definition photos. An embodiment may be mountable onto an existing camera lens. It may create a “new dimension” due to the roundness/thickness of the objects photographed. It may capture movement or moving objects in HD without losing detail.

Embodiments include cleared separation between main object(s) and the background. An embodiment may be applied with a large aperture lens (f/2.8 or larger), which captures sharp and stunning HD photos. By the same token, using a smaller aperture (f5.6 thru f8.0) still makes the background blurred and broken. Embodiments work on portrait or people photos. Embodiments will not affect a camera's focus points at all.

As depicted in FIG. 4, an embodiment 10 of an HD device may be screwed into the front of the lens of a camera 30. To use an embodiment, mount to the outside of the camera lens. Screw in to front of the camera lens as same as the lens filters or mount to the inside of the camera lens. This could also be done by the lens manufacturer.

As depicted in the embodiment of FIG. 5, light 32 comes in and bounces through blocking rods 18, 20, 24 of the multiple lenses or layers 12, 14, 16. Due to the delay provoked by emission and reabsorption, the effective travel time of a light ray is effectively slowed each time it hits the blocking rods. If more devices are attached in front of the lens, the light will be slower and slower going through each device. Because the light goes through the HD device(s) and camera lens slower, it will capture object(s) with more details. Even though the light goes through slower; the camera sensor still captures object(s) that appear normal, as if there was no added device. As a result, the object(s) will be provided to the camera 30 in layers that create high definition (HD) images 34.

It should be understood, of course, that the foregoing relates to exemplary embodiments of the invention and that modifications may be made without departing from the spirit and scope of the invention as set forth in the following claims.

We claim:

1. A device for providing an enhanced image of an item, comprising:
a lens for receiving light and transmitting an image; and
a plurality of parallel blocking rods to delay the light within the lens;
wherein the lens receives the light, the rods delay the light, and the lens transmits the delayed light, thereby providing an enhanced image of the item.

2. The device of claim 1, wherein the lens is adapted to affix to a camera, thereby providing an enhanced image to the camera.

3. The device of claim 1, wherein the lens includes a plurality of plates having generally the same size, transparently fixed together so as to have a common central axis.

4. The device of claim 3, each plate having parallel rods in different plates, the parallel rods in each plate orientated at a different angle from rods in other plates, thereby delaying the light within the plates.

5. The device of claim 3, wherein the lens has an aperture that is F/2.8 or larger.

6. A lens, comprising:
a plurality of light blocking rods at different orientations so as to delay light within the lens.

7. The lens of claim 6, further comprising
a plurality of layers, each layer having a plurality of parallel light blocking rods, the rods in each layer at a different orientation from the rods in other layers.

8. A method of providing an enhanced image, comprising:
receiving a first image into a lens;
delaying the light within the lens utilizing a plurality of parallel blocking rods; and
transmitting the delayed light out of the lens;
thereby providing an enhanced image.

9. The method of claim 8, further comprising:
affixing the lens to a camera, thereby providing an enhanced image to the camera.

10. The method of claim 8, further comprising:
delaying the light within a plurality of lenses, each lens having parallel blocking rods at a different orientation.
